(19) United States
(12) Patent Application Publication
(10) Pub. No.: US 2002/0031675 A1
(43) Pub. Date: Mar. 14, 2002

(54) Partially stabilized zirconia biocomponent having high resistance to low temperature degradation and a method of preparing same

(76) Inventors: Bernard Cales, Evreux (FR); Laurence Blaise, Evreux (FR); Franceline Villermaux, Avignon (FR)

Correspondence Address: Michael L. Goldman, NIXON PEABODY LLP, Clinton Square, P.O. Box 31051, Rochester, NY, 14603, US

(21) Appl. No.: 09/840,950

(22) Filed: Apr. 24, 2001

Related U.S. Application Data
(60) Provisional application No. 60/200,123, filed on Apr. 27, 2000.

(51) Int. Cl. B32B 9/00

(52) U.S. Cl. 428/472; 428/699; 428/701

(57) ABSTRACT

A biomedical component comprising sintered yttria tetragonal zirconia ceramic (YTZP), the YTZP comprising at least 90 mol % ZrO₂, the ZrO₂ being partially stabilized with at least 2.1 mol % yttria, wherein the YTZP further comprises between 0.05 wt % and 1 wt % alumina, wherein the YTZP has a density of at least 99% of theoretical density and has a grain size, as measured by the linear intercept method, of no more than 1 micron, and wherein the yttria is homogeneously distributed within the zirconia.

### BACKGROUND OF THE INVENTION

Partially Stabilized Zirconia and in particular Yttria Partially Stabilized Zirconia (YTZP) has been successfully used as a material for biomedical prosthesis applications (see in particular : Piconi C, Maccauro G : Zirconia as a ceramic biomaterial: Biomaterials 20: 1-25, 1999 ; or Calès B, Stefani Y: Yttria-Stabilized Zirconia for Improved Orthopedic Prostheses. In Wise D L, Trantolo D J, Altobelli D E, et al (eds), Encyclopedic Handbook of Biomaterials and Bioengineering. Vol 1B. New York, Marcel Dekker 415-452 1995).

There are a number of disclosures reporting YTZPs having alumina additions (i.e. aluminium oxyde A1203),—see in particular: Inagaki K, Okumura F, Sakaki T, Corrosion Resistance of Partially Stabilized Zirconia, J. Tosoh Res. 35, 1 37-43 1991 ; or Tsubakino H, Nozato R, Hamamoto M, Effect of Alumina addition on the tetragonal-to-monoclinic phase transformation in Zirconia-3 mol. % yttria in J. Am Ceram. Soc, 74[2] 440-443 (1991). However, all of these disclosures apparently teach one-step pressureless sintering of the zirconia green body. If only pressureless sintering is carried out in the densification process, then very prolonged sintering times are needed in order to achieve high density (i.e., greater than 99% of theoretical density). When such prolonged sintering is undertaken, the zirconia grains in the green body undergo coarsening and grow to the undesirably large size of more than 1 micron.

There are also a number of disclosures related to YTZPs in which 2-step sintering occurs, with a first pressureless sintering followed by an additional sintering by hot isostatically pressing (HIP) (see in particular: T. Masaki, K Nakajima, K Shinjo, J. Mat Sci. Letters 5, 1115-1118 1986 ; H. Reh, Interceram 6, 56-63 1986 ; or J-Y Kim, N. Uchida, K Uematsu, J. Ceram Soc Japan, 1000323-26 1992). However, it appears that all of these disclosures fail to further recite an alumina addition.

There are also known YTZP biomedical components made by densifying green bodies produced from (and containing) yttria-coated zirconia particles (W. Burger, H G Richter, C. Piconi et al. In Andersson Ö H Happonen R P, Yli-Urpo A (eds). Bioceramics 7. Oxford, Butterworth-Heinemann 389-394, 1994). That is, the method by which yttria is added to the zirconia powder mixture is by coating the zirconia particles with yttria, to the contrary of the other powders, wherein the zirconia-yttria mixture is obtained by co-precipitation. However, this method of alloying does not provide for sufficiently homogeneously distributed yttria within the sintered zirconia body, as the yttria is only on the surface of the zirconia particles.

Although YTZP zirconia ceramics are known to have high strength and toughness, they are also known to be susceptible to strength degradation (i.e., Low Temperature Degradation or LTD) upon exposure to steam in temperatures between 150° C. and 500° C. The origin of this LTD phenomenon is believed to be attributed to a reaction between water and Zr—O—Zr bonds of the ceramic. This reaction causes a transformation of zirconia grains from their desired tetragonal state to their monoclinic state. This transformation is also accompanied by a volume expansion in the transformed grain of about 4%, which causes microcracking in the component and consequent strength degradation.

### SUMMARY OF THE INVENTION

An object of the invention is to alleviate the drawbacks of the known solutions, i.e. to provide an YZTP zirconia material having a high resistance to LTD, while having a density close to the theoretical density, and a good homogeneity in the distribution of yttria.

As a matter of fact, the present inventor believes, despite the prior art teachings, that a yttria doped zirconia material, in particular an YTZP, which is highly resistant to LTD can be made by:

a) using a powder of yttria doped zirconia obtained by co-precipitation,

b) adding a small amount of alumina powder (i.e., between about 0.05 wt % and 1 wt % alumina) to this co-precipitated yttria-zirconia powder to form a mixture,

c) forming a green body from the powder mixture,

d) pressureless sintering the green body, and

e) hot isostatically pressing (“hipping”) the sintered body and increasing its density.

When these steps are carried out, the resulting body is found to have higher resistance to LTD than the conventional methods discussed above.

Without wishing to be tied to a theory, it is believed that the use of co-precipitated powder is advantageous because it provides for a very high degree of local homogeneity (at the microscopic scale) with the dense body. It has been shown that the LTD resistance of YTZPs is a function of yttria concentration, of uniformity and grain size, and flaw population (Cales et al., J. Biomed. Mat. Res.,28, 619-24, 1994). It is the reason why, for the purpose of the present invention, co-precipitated yttria-zirconia powders are preferably used which contain yttria which is homogeneously distributed within the zirconia.

Without wishing to be tied to a theory, it is believed that the addition of a small amount of alumina in the green body has the effect to change the microstructure of the sintered ceramic body and thus to increase its resistance to LTD.

Without wishing to be tied to a theory, it is believed that using hipping to provide full densification (instead of prolonged sintering) beneficially reduces the amount of zirconia grain coarsening, thereby allowing the zirconia grain size to remain in the desirable submicron range (mean grain size less than 1 μm.

Therefore, in accordance with the present invention, there is provided a biomedical component comprising sintered yttria doped tetragonal zirconia ceramic (YTZP), the YTZP comprising at least 90 mol % ZrO₂, and at least 2.1 mol % yttria, wherein the YTZP further comprises between 0.01 wt % and 1 wt % alumina, wherein the YTZP has a density of at least 99% of theoretical density and has a grain size, as measured by the linear intercept method, of no more than 1 micron, and wherein the yttria is homogeneously distributed within the zirconia.

Preferably, this zirconia is stabilized in the tetragonal state by 2.5 mol. % and 3.5 mol. % of yttria Y2O3.

The YTZP ceramic of the present invention has high resistance to LTD. That is, the YTZP ceramic has a surface monoclinic content of no more than 10% (preferably no more than 8%, more preferably no more than 5%) after exposure to five cycles of 134° C. steam at 2 bars for 20 hours, i.e. a total exposure time of 100 hours.

According to preferred possibly combined features of the invention:

the ceramic contains between 96.5 mol. % and 97.5 mol. % zirconia,

the alumina content is comprised between 0.05 wt. % and 0.15 wt. %,

the ceramic has a density of at least 99.5% of the theoretical density,

the ceramic has a surface havint a roughness Ra less than 10 mn,

the mean grain size is less than 0.5 micron.

The above-mentioned component is advantageously a hip joint prosthesis head, an insert for an acetabular cup, a tibial plate, a femoral component for a knee prosthesis, an inter-vertebral disc, or a tooth prosthesis component.

### DETAILED DESCRIPTION OF THE INVENTION

Objects, characteristics and advantages of the invention appear from the following description, given as a non limitative illustrative example only, with reference to the enclosed drawings wherein:

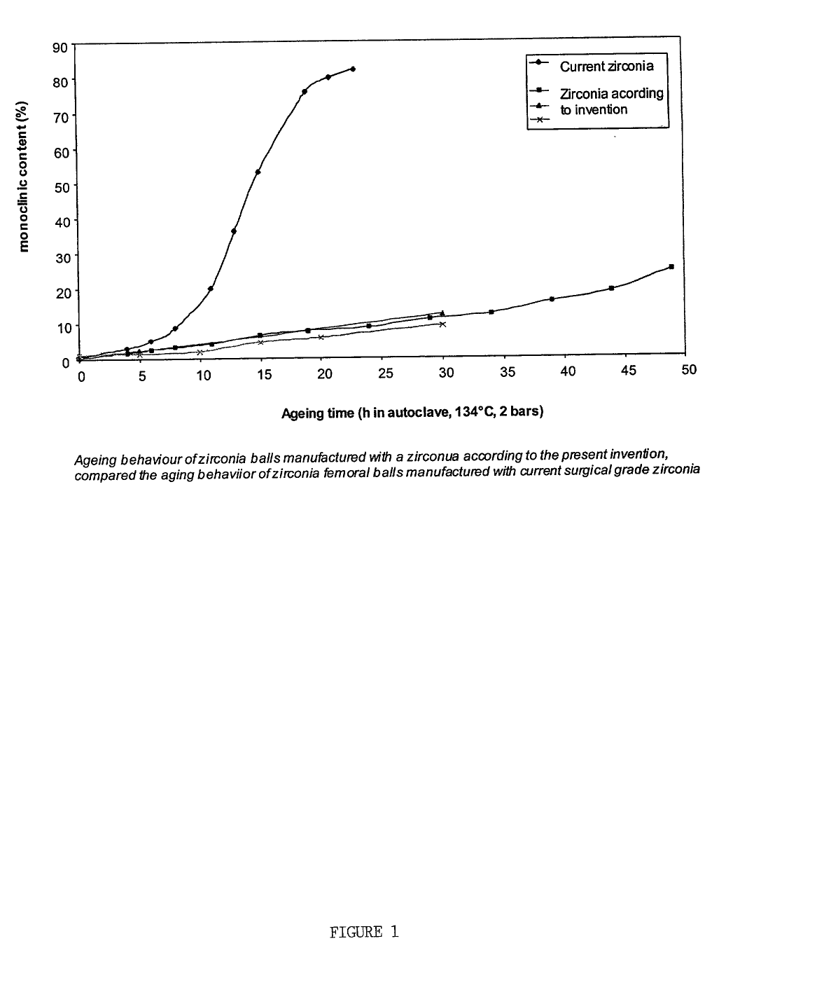

FIG. 1 is a diagram showing the evolution of the monoclinic phase content as a function of the treatment in autoclave (in hours at 134° C. under 2 bars) of femoral heads prepared with a classical zirconia and with zirconia according to the invention, and

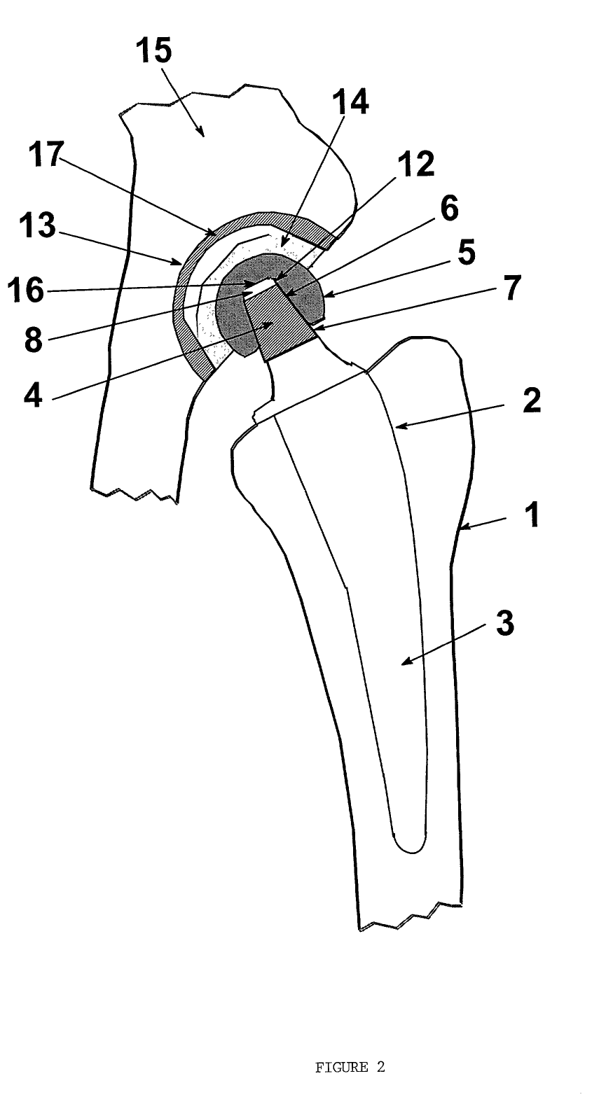

FIG. 2 is an example of a biocomponent, within a hip joint prosthesis.

For the purposes of the present invention, the surface monoclinic content of the zirconia is defined as the monoclinic content measured by X-ray diffraction (CuKα, penetration depth of 5 mm); surface roughness Ra is measured by optical interferometry; the yttria content of the YTZP is provided in mole percent (mol %) and is calculated based solely upon the molar fraction of yttria to (zirconia+hafnia (impurity)+yttria). The zirconia fraction is considered to include the typical contamination by hafnia (which may be up to 5%).

In one preferred method of making the YTZP of the present invention, a co-precipitated submicron powder comprising 3 mol. % yttria and zirconia is mixed with a 0.01 wt % of 0.45 μm alumina powder, the mixed powder is cold isostatically pressed at between 50 and 400 MPa and appropriately green machined to form a green biomedical component. Once the green component is formed, it is then sintered at between about 1300° C. and 1500° C. for about 1 to 4 hours to achieve a density of at least 95% of the theoretical density; and the sintered piece is hot isostatically pressed (“hipped”) in an inert gas such as argon at between 1300° C. and 1500° C. for between 0.5 and 4 hours to produce a sintered component having a density of at least 99.9% of the theoretical density. The HIP treatment may induce a more or less significant blackening of the zirconia ceramic as a result of the loss of oxygen. Recovery to the stoichiometry and to the classical white-creamy color is advantageously obtained, if the need arises, by an annealing at a temperature of 900° C. to 1200° C. during 2 to 5 hours. The sintered piece is then, if appropriate, final machined to the desired shape.

In order to insure that the YTZP material of the present invention is suitably resistant to LTD, the following process steps should be preferably taken:

optimizing the composition with an yttrium oxide content of more than 2.1 mol % and advantageously between 2.5% and 3.5%, preferably between 2.9 and 3.2 mol %, more preferably about 3 mol %;

sintering at the lowest temperature to insure at least 95% of theoretical density, for instance in the range 1400-1450° C.;

hot isostatic pressing the already-sintered body in order to reach full density ( 99% of theoretical); and

quite advantageously, finishing and polishing the working surface (i.e., the surface in contact with human fluid) in order to reach a very low surface roughness. Preferably, the biocomponent has a surface having a surface roughness Ra of no more (less) than 10 nm, more preferably no more than 5 nm.

In some preferred embodiments, the YTZP material having high LTD resistance has very low porosity of less than 0.4 vol %, preferably less than 0.1%. Without wishing to be tied to a theory, it is believed that the transformation of the tetragonal grains to monoclinic grains initially occurs in the vicinity of surface pores. Therefore, eliminating these pores has a tendency to reduce the transformation to monoclinic. In some embodiments, pores in a pressureless sintered YTZP material (which typically possesses at least 1.5 vol % porosity) may be eliminated by hot isostatic pressing that material to essentially full density.

In some preferred embodiment, the mean grain size of the YTZP is less than 0.5 um. The smaller grains of this preferred embodiment make the YTZP grains even more resistant to LTD phenomena. In more preferred embodiments, however, the grain size of the YTZP is between 0.30 and 0.45 μm. In this more preferred range, the grains are small enough to resist LTD but not so small as to eliminate the beneficial transformation capability (from tetragonal to monoclinic) which provides high strength and toughness.

In general, actual grain size measurements (G) can be converted to average linear intercept measurements (L) by the following formula: G=1.56 L.

Compositionally, the YTZP bioprosthetic component preferably comprises at least about 90 mol % zirconia (which includes its hafnia content). More preferably, it comprises between 96.5 mol % and 97.5 mol % zirconia. Preferably, the YTZP is partially stabilized by yttria at a concentration of between 2.5 and 3.5 mol % (based upon the zirconia+hafnia fraction), most preferably between about 2.9 mol % and 3.1 mol % yttria. When yttria is provided in this range, the zirconia in the sintered YTZP body typically comprises at least about 95% tetragonal phase, more preferably at least 99%. Preferably, the YTZP contains between about 0.05 wt % and 1 wt % alumina, more preferably between 0.05 wt % and 0.15 wt % alumina.

Microstructurally, preferably, the YTZP grains have a mean grain size (SEM using ASTM E 112/82) of no more than 0.5 micron (μm), preferably between 0.32 and 0.45 μm. Also preferably, the alumina grains has a mean grain size (SEM using ASTM E 112/82) of no more than 1 micron (μm), preferably between 0.3 and 0.8 ═m. Its density should be between 99 and 100% of theoretical density. Preferably, it should have an open porosity of no more than 0.1 vol. %.

In mechanical performance, the bulk of the YTZP bioprosthetic component should have a four point flexural strength of at least about 1300 MPa and is typically between 1300 and 2000 MPa. In some embodiments, the bulk has an elasticity modulus of no more than 230 GPa, and is typically between 200 and 230 GPa. It typically has a fracture toughness (as per Chantikul) of at least 5 MPa m^{½}, and is likely typically between 5 and 10 MPa m^{½}.

The monoclinic content of a virgin surface of the YTZP produced in accordance with the present invention is preferably less than 5 vol. %, more preferably less than 2%. This YTZP material of the present invention can be evaluated for LTD resistance by exposing a polished sample thereof five cycles of 134° C. steam at 2 bars for 20 hours. As it will be apparent hereinbelow, the post-exposure monoclinic content of the thus-exposed surface has been found to be no more than about 10 vol. % monoclinic, preferably less than 8 % and more preferably less than 5%. As these test conditions likely simulate a 100 year exposure in the body at 37° C., the low monoclinic content of the aged material (after test) indicates that this YTZP is superior in LTD resistance and advantageously suitable for use as a biomedical component.

For comparison purposes, some conventional YTZP have been similarly tested for LTD resistance (five cycles at 134° C. steam under 2 bars during 20 hours). The results of these tests of found in Table I below:

TABLE I

| | Surface |
|---|---|
| Example | Monoclinic Content |
| Present invention | 10% |
| Ripped, with no alumina addition | 80% |
| Sintered Only, no alumina addition | 90% |
| Ripped, alumina addition, yttria-coated zirconia | 25% |

FIG. 1 shows the evolution of this surface monoclinic phase content as a function of the ageing time under the above mentioned conditions.

For these tests, an hip joint prosthesis femoral head has been prepared from a co-precipitated submicron powder of zirconia containing 3 mol. % yttria and comprising an addition of 0.24 wt. % alumina submicron powder. The piece was obtained by isostatic pressing at 1000 bars, then sintering at 1400° C. during 3 hours. It was then hot isostatically pressed (HIP) in argon at 1400° C. during 1 hour to reach theoretical density. After hipping, a whitening, or stoichiometric composition recovery, annealing was conducted at a temperature of about 1000° C. during 2 hours.

The piece has then been polished to reach a surface having a roughness Ra less than 5 nm (<0.005 μm). The resistance to ageing was evaluated by measures of the surface monoclinic phase content by X-diffraction, after autoclave treatment at 134° C. steam under 2 bars. Preliminary studies showed that a 1 h-treatment in autoclave at 134° C. steam under 2 bars corresponded for the zirconia ceramic of the invention to an ageing in physiologic conditions during 4 years (Calès B.: Zirconia as a sliding material: Histology, laboratory and clinica data. Clinical Orthop Rel Res 379: 94-112, 2000).

Measures of monoclinic phase content at the surface of three femoral heads according to the invention, what is a quite liable indicator of the ageing of the zirconia, have been compared to measures made on femoral heads produced by the same method but from a conventional powder, (in particular, without an addition of a small amount of alumina). The results or FIG. 1 very clearly show, in the components of the invention, a very strong reduction of the transformation of zirconia in monoclinic phase with respect to classical components, since a content of no more than 10 vol. % of monoclinic phase is seen at the surface of femoral heads of the invention after a treatment of 25 hours in autoclave at 134° C. under 2 bars, i.e. an equivalent of 200 years in physiologic conditions. In the case of a femoral head produced from a conventional zirconia powder, this monoclinic phase content of 10 vol. % is obtained after 8 hours only in the autoclave, i.e. the equivalent of 32 years in physiologic conditions.

The above-mentioned femoral head is for example a part of the hip joint prosthesis of FIG. 2, cooperating with a femur 1 by a metal trunnion 2, and with the pelvic bone 15. A first end 3 of metal trunnion 2 is implanted into femur 1. The second end of the trunnion 2 is shaped to a frustocone 4 which cooperates with a ceramic head 5 according to the invention. The recess of this head has about the same taper (conical angle) angle as cone 4 and is press fit onto this cone 4. Taper wall 6 of the head 5 defined by the frustoconical recess is in contact over its substantial length with the surface 7 of the frustocone 4. A reserve 8 between the frustocone 4 and the femoral head crown 16 is also shown. The junction 12 of the crown 16 of conical recess and the taper wall 6 may be, in some embodiments, a cylinder with connection curvature radii or a crown corner. Concurrently, an acetabular cup 13 having a YZTP zirconia ceramic socket insert 14 which is taper locked in a metal backing 17 is fitted into the pelvic bone 15. Lastly, the YZTP zirconia ceramic head 5 is positioned in the zirconia ceramic socket insert 14 of the acetabular cup 13 to form the hip joint.

Generally, the YTZP zirconia biocomponent of the invention can be used at any site in the body for which alumina, zirconia or ZTA ceramic are currently used. These applications include:

femoral hip joint prosthesis heads, such as the designs shown in U.S. Pat. No. 5,181,929 (“Prats”), U.S. Pat. No. 4,964,869 (Auclair”) and U.S. Pat. No. 5,972,033 (“Drouin”);

monolithic acetabular cups;

modular acetabular cups (inserts) designed for taper-fit for reception in metal backings, such as the designs shown in U.S. Pat. No. 5,879,397; U.S. Pat. No. 5,609,647; and U.S. Pat. No. 5,919,236, (each of the above specifications are incorporated herein by reference);

tibial plate components;

femoral knee components;

intervetebral discs, and;

tooth prosthesis components.

Therefore, in accordance with the present invention, there is provided an acetabular cup for receiving a hip joint prosthesis head having an substantially spherical convex outer surface, the cup comprising:

a) a YTZP ceramic component of the present invention having a substantially spherical socket surface shaped to rotatably receive the spherical outer surface of the hip joint head, and

b) a metal backing in which the ceramic component is received, preferably press-fit or interference fit, wherein the ceramic component is fit either i) directly within the metal backing, or ii) within a plastic insert, the plastic insert itself being interference fit within the metal backing.

Also in accordance with the present invention, there is provided a YTZP ceramic acetabular cup insert of the present invention for receiving a hip joint prosthesis head having a substantially spherical convex outer surface, the insert comprising:

a) a substantially spherical socket surface shaped to rotatably receive the spherical convex outer surface of the hip joint head, and

b) a back surface shaped (preferably, frustoconically shaped) to be received in a metal backing.

Also in accordance with the present invention, there is provided a YTZP ceramic of the present invention femoral hip joint prosthesis head comprising:

a) a substantially spherical convex outer surface, and

b) a recess which forms a frustoconical taper wall extending inward from the outer diameter of the head, wherein the taper wall has a shape suitable for taper fitting upon a frustoconical trunnion to produce contact between the taper wall and a first section of the frustoconical end of the trunnion.

Also in accordance with the present invention, there is provided a joint prosthesis, such as a hip joint prosthesis, comprising:

a) a substantially spherical ceramic head comprising YTZP of the present invention,

b) an acetabular cup having a substantially spherical ceramic socket surface comprising YTZP of the present invention shaped to rotatably receive the outer surface of the ceramic head, wherein the outer surface of the head is received on the surface of the second component (this case corresponds to FIG. 2).

Also in accordance with the present invention, there is provided a tooth prosthesis component made of the material of the invention.

We claim:

1. A biomedical component comprising sintered yttria doped tetragonal zirconia (YTZP) ceramic, the YTZP comprising at least 90 mol % ZrO₂ and at least 2.1 mol % yttria, between 0.01 wt % and 1 wt % alumina, wherein the YTZP ceramic has a density of at least 99% of theoretical density and has a grain size, as measured by the linear intercept method, of no more than 1 micron, and wherein the yttria is homogeneously distributed within the zirconia.

2. The component of claim 1 where the ZrO₂ is partially stabilized in tetragonal state with between 2.5 and 3.5 mol % yttria.

3. The component of claim 1 or claim 2 wherein the YTZP comprises between 96.5 and 97.5% zirconia.

4. The component of any one of claims 1 to 3 wherein the alumina content is between 0.05 and 0.15 wt %.

5. The component of any one of claims 1 to 4 wherein the YTZP ceramic has a surface having a surface monoclinic content of less than 10 vol. % after exposure to five cycles of 134° C. steam at 2 bars for 20 hours.

6. The component of claim 5 wherein the YTZP has a surface having a surface monoclinic content of less than vol. 8% after exposure to five cycles of 134° C. steam at 2 bars for 20 hours.

7. The component of claim 6 wherein the YZTP has a surface having a surface monoclinic content of less than 5 vol. % after exposure to five cycles of 134° C. steam at 2 bars for 20 hours.

8. The component of any one of claims 1 to 7 wherein the YTZP ceramic has a density of at least 99.5% of theoretical density.

9. The component of any one of claims 1 to 8 wherein the YZTP has a surface having a surface roughness Ra less than 10 nm.

10. The component of any one of claims 1 to 9 wherein the ceramic has a mean grain size of less than 0.5 μm.

11. The component of any one of claims 1 to 10 wherein the component is a hip joint prosthesis head.

12. The component of any one of claims 1 to 10 wherein the component is an insert for an acetabular cup.

13. The component of any one of claims 1 to 10 wherein the component is a tibial plate.

14. The component of any one of claims 1 to 10 wherein the component is a femoral knee component.

15. The component of any one of claims 1 to 10 wherein the component is an intervertebral disc.

16. The component of any one of claims 1 to 10 wherein the component is a tooth prosthesis component.

17. A method for producing a biocomponent essentially comprising yttria doped zirconia ceramic comprising the steps of:
using a yttria doped powder being obtained by co-precipitation, the powder containing at least 2.1 wt. % yttria,
adding an amount of alumina powder of at most 1 wt. %,
producing a green body from a mixture of the powders,
pressureless sintering of the green body,
submitting the sintered body to an additional densification step by hot isostatic pressing.

18. The method of claim 17 wherein the zirconia powder contains between 2.9 mol. % and 3.2 mol. % yttria.

19. The method of claim 17 or claim 18 wherein the alumina content is between 0.01 wt. % and 1 wt. %

20. The method of anyone of claims 17 to 19 wherein the zirconia and alumina powders have grain sizes of less than 1 micron.
